(19) United States
(12) Patent Application Publication
(10) Pub. No.: US 2014/0068696 A1
(43) Pub. Date: Mar. 6, 2014

(54) PARTIAL AND RISK-BASED DATA FLOW CONTROL IN CLOUD ENVIRONMENTS

(71) Applicant: Andreas Schaad, Karlsruhe (DE)

(72) Inventor: Andreas Schaad, Karlsruhe (DE)

(73) Assignee: SAP AG, Walldorf (DE)

(21) Appl. No.: 13/598,916

(22) Filed: Aug. 30, 2012

(51) Int. Cl. G06F 21/00; G06F 15/16

(52) U.S. Cl. 726/1

(57) ABSTRACT

Implementations of the present disclosure include methods, systems, and computer-readable storage mediums for risk-based data flow control in a cloud environment. Implementations include actions of intercepting first data transmitted from a first application to a second application before receipt of the first data at the second application, the first application and the second application being hosted within the cloud environment, processing the first data to provide a first risk factor, the first risk factor reflecting a degree of risk if the first data is received by the second application, generating first sanitized data based on the first data, the first risk factor and a first access control policy associated with the first data and transmitting the first sanitized data to the second application.

### BACKGROUND

Enterprises are increasingly using cloud environments because of their numerous benefits. In some examples, enterprises can use a cloud environment to offset their IT investment, enabling them to focus their resources. In some examples, enterprises can use a cloud environment to leverage cloud resources to automatically handle a required workload. Regardless, of the motivation for using a cloud environment, an enterprise must consider several conditions to optimize the business value. The most common condition verified by an enterprise aiming at using a cloud environment is security.

An enterprise needs to define and identify the security requirements for a cloud environment to ensure that data is only accessible by intended parties. Traditional cloud environment security either fully grants or fully denies access to data. A full denial of access to the data ensures that the cloud environment itself is stable and secure so that no other customer within the boundary of that cloud can access or otherwise compromise data.

### SUMMARY

Implementations of the present disclosure include computer-implemented methods for risk-based data flow control in a cloud environment, the methods being performed using one or more processors and including actions of intercepting first data transmitted from a first application to a second application before receipt of the first data at the second application, the first application and the second application being hosted within the cloud environment, processing the first data to provide a first risk factor, the first risk factor reflecting a degree of risk if the first data is received by the second application, generating first sanitized data based on the first data, the first risk factor and a first access control policy associated with the first data, and transmitting the first sanitized data to the second application.

In some implementations, the first sanitized data includes less data than the first data.

In some implementations, the first sanitized data includes different data values than the first data.

In some implementations, the first access control policy provides that access to the first data is to be denied.

In some implementations, generating first sanitized data based on the first data, the first risk factor and a first access control policy associated with the first data includes: determining that access of the second application to the first data is denied based on the first access control policy, selecting a risk threshold based on determining that access of the second application to the first data is denied, and determining that the first risk factor exceeds the risk threshold and, in response, generating the first sanitized data.

In some implementations, the first risk factor is determined based on one or more non-intended usages of at least a portion of the first data and one or more probabilities, each probability being associated with a respective non-intended usage.

In some implementations, actions further include deploying the first application to the cloud environment by: expressing intended use of one or more declassification techniques, providing registration requirements for the cloud environment, registering a data flow control service at the cloud environment, registering an application data schema of the first application and one or more general domain risks at the cloud environment, and deploying the first application.

In some implementations, actions further include intercepting second data transmitted from the first application to the second application before receipt of the second data at the second application, processing the second data to provide a second risk factor, the second risk factor reflecting a degree of risk if the second data is received by the second application, and blocking transmission of the second data to the second application.

In some implementations, blocking transmission of the second data to the second application occurs in response to determining that the second risk factor exceeds a risk threshold.

In some implementations, actions further include determining that a second access control policy associated with the second data provides that access to the second data is to be granted and, in response, providing a value of the risk threshold.

In some implementations, actions further include intercepting second data transmitted from the first application to the second application before receipt of the second data at the second application, processing the second data to provide a second risk factor, the second risk factor reflecting a degree of risk if the second data is received by the second application, and transmitting the second data to the second application.

In some implementations, transmitting the second data to the second application occurs in response to determining that the second risk factor is less than a risk threshold.

In some implementations, actions further include determining that a second access control policy associated with the second data provides that access to the second data is to be granted and, in response, providing a value of the risk threshold.

In some implementations, the risk includes a risk of an unwanted event occurring as a consequence of providing the first data to the second application.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 is a block diagram of an example system architecture that can execute implementations of the present disclosure.

FIG. 2 depicts information flow from the perspective of an application developer.

FIG. 3 depicts information flow from the perspective of an application operator.

FIG. 4 depicts information flow from the perspective of an end user.

FIG. 5 is a flowchart depicting an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are generally directed to providing partial and risk-based data flow control in cloud environments. More particularly, implementations of the present disclosure are directed to partial and risk-based data flow control in cloud environments that support secure and compliant data flow between hosted applications. In some implementations, a data flow control system observes data transfer between applications. In some examples, the data flow control system can determine that data from a providing application is to be evaluated before the data is received by a receiving application. In some examples, evaluation includes performing a check against standard access and usage control policies and performing a risk assessment. In some examples, the risk assessment includes a risk factor that reflects a degree of risk if the data is able to freely flow to the receiving application. In some examples, the data flow control system can fully block, partially grant (partially block) or fully grant the receiving application access to the data. In some examples, partially granting (partially blocking) access to the data can include sanitizing the data to provide sanitized data, such that the receiving application receives the sanitized data (e.g., in lieu of the original data).

Implementations of the present disclosure will be described in view of an example context. The example context includes real-time promotional offer management services in the retail domain. In some examples, a retail enterprise can provide real-time promotional offers to end users (e.g., customers). For example, an end user can have a computing device that can execute a client-side application. The client-side application can receive real-time promotional offers and can display the offers to the user on the computing device. The real-time promotional offers can be provided by a promotional offer management application that can be hosted on a backend system (e.g., on the cloud). The client-side application can communicate with the promotional offer management application. In some examples, the backend system is provided by a service provider (e.g., a cloud service provider).

Continuing with the example context, the promotional offer management application can access one or more other services provided by third-party applications. For example, a third-party application can include a recommendation engine that generates promotional offer recommendations that can be specific to an end user. In some examples, the third-party applications are hosted on the backend system. In some examples, the promotional offer management application can provide data to the recommendation engine, which can process the data and can provide promotional offer recommendations in response. One or more of the promotional offer recommendations can be provided to the end user from the promotional offer management application.

Although implementations of the present disclosure are discussed herein with reference to the example context described above, it is appreciated that implementations are applicable in other contexts. For example, another example context can include healthcare services to compute personal coaching advice. In some examples, entities, such as health and wellness providers, can use the healthcare services to retrieve patient data on physical activities (e.g., from a data store or directly from the patients' mobile devices). Analysis functions can be provided by another service provider, and a billing service can be provided. Though patient information is extremely sensitive, some form of access to the patient data or to information derived from the patient data can be provided using implementations of the present disclosure (e.g., for diagnosis, to provide home healthcare and/or for billing/insurance).

As discussed in further detail herein, implementations of the present disclosure provide partial and risk-based data flow control. Implementations of the present disclosure can be provided in cloud environments that support secure and compliant data flow between hosted applications. In some examples, the cloud environment hosts applications that can communicate with one another. For example, an application can access services provided by one or more third-party applications. In the example context, the promotional offer management service can access services, such as the recommendation engine, provided by one or more third-party developers. In some examples, applications hosted in the cloud environment can be accessible from various end user devices over a network.

In some implementations, the cloud environment can be designed to include risk-based data flow control to enable secure data flow between multiple applications. In some implementations, particular security policies (e.g., access control) might be required for a particular application. In some implementations, security policies for a particular application can be associated with the risk of data flowing between applications against the security policy. In some implementations, the cloud environment can reference the security policies required by the application owners and allow third parties to subscribe to one or more applications providing risk-based data flow control.

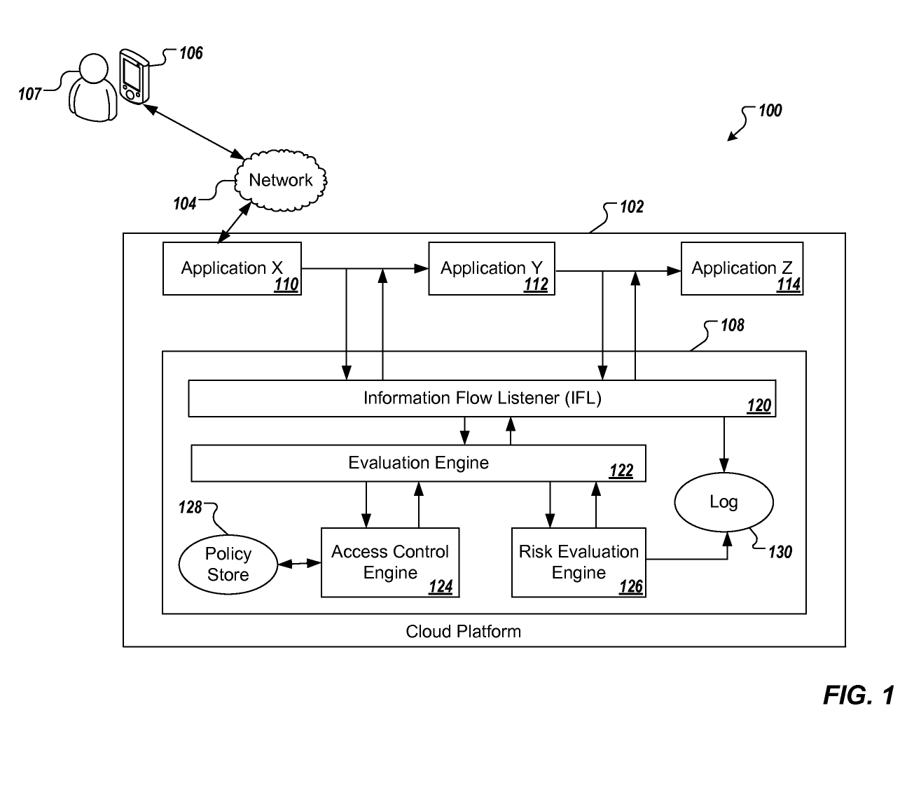

FIG. 1 depicts an example system architecture 100 that can execute implementations of the present disclosure. In some implementations, the example system architecture 100 can include a cloud platform 102 (cloud environment), a network 104 and a computing device 106. In some examples, the cloud platform 102 is provided by one or more computing devices (e.g., servers). For example, one or more server computing devices can execute one or more computer program applications to provide the cloud platform 102. In some examples, the computing device 106 can communicate with one or more applications hosted on the cloud platform 102 over the network. In some examples, the computing device 106 can be associated with a user 107 and can be provided as a laptop computer, a desktop computer, a smartphone, a tablet computing device, a personal digital assistant, a portable media player, or other appropriate computing devices or combinations thereof. Although a single computing device 106 is depicted, it is appreciated that multiple computing devices 106 can communicate with the cloud platform 102 over the network 104. In some implementations, the network 104 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

The cloud platform 102 includes a data flow control system 108. In the depicted example, the cloud platform hosts applications 110, 112, 114, respectively. As depicted in FIG. 1, implementations of the data flow control system 108 include an information flow listener (IFL) 120, an evaluation engine 122, an access control engine 124, a risk evaluation engine 126, a policy store 128 and a log 130. In some implementations, and as discussed in further detail herein, the user 107 can interact with the application 110. For example, the application 110 can receive user input and/or user data from the computing device 106. In some examples, the application 110 provides a service (e.g., provided by an enterprise to end users). In the example context, the application 110 can provide functionality of the promotional offer management system. For example, a retail enterprise can provide the promotional offer management system for use by customers (e.g., the user 107). In some examples, each of the IFL 120, the evaluation engine 122, the access control engine 124 and the risk evaluation engine 126 can be provided as one or more computer-executable programs that can be executed by one or more computing devices (e.g., servers). In some examples, the policy store 128 and the log 130 are provided as computer-readable memory.

In some implementations, the cloud platform 102 can be described in the general context of computer-executable instructions, such as program modules, being executed by one or more computer systems. Generally, program modules of a cloud platform can include routines, programs, objects, components, logic, and/or data structures that perform particular tasks or implement particular abstract data types. In some implementations, a cloud platform can include distributed cloud computing environments linked through a communications network. In some implementations, a cloud platform can be located in both local and remote computer system storage media including memory storage devices.

In some implementations, one or more applications (e.g., the application 110) hosted by the cloud platform 102 can receive input from a user. For example, the user 107 can interact with the application 110, whereby the application 110 can receive user input and/or user data from the computing device 106. In some implementations, the application 110 can interact with other applications hosted by the cloud platform 102. In the depicted example, the application 110 can interact with the application 112. For example, the application 112 can provide a service that is made accessible to the application 110. In the example context, the application 110 can provide functionality of the promotional offer management system and the application 112 can provide functionality of a recommendation engine. To that end, the application 110 can transmit data to the application 112 (e.g., data flow), and the application 112 can transmit data to the application 110.

In some implementations, and as discussed in further detail herein, the data flow control system 108 regulates data flow between applications hosted on the cloud platform 102. In some examples, the data flow control system 108 can fully block, partially grant (partially block) or fully grant a receiving application access to data being transferred from a providing application. In some examples, partially granting (partially blocking) access to the data can include sanitizing the data, such that the receiving application receives sanitized data instead of the original data.

To that end, the IFL 120 monitors data transfer between applications. For example, the IFL 120 can observe data transfer between the application 110 and the application 112 and can intercept the data to perform partial and risk-based data flow control in conjunction with other components of the data flow control system 108. In the depicted example, the IFL 120 monitors data transfer between the application 110 and the application 112, as well as between the application 112 and the application 114. In some implementations, the IFL 120 can process the data and can determine whether the data should be evaluated for access control. For example, the IFL 120 can determine that the data includes potentially sensitive data. In some examples, sensitive data can include user data. In the example context, example user data can include personal data such as name, address, preferences, credit card information, shopping history and the like. In some implementations, the IFL 120 provides the data to the evaluation engine 122.

In some implementations, the evaluation engine 122 provides the coordinating enforcement infrastructure, which grants or denies access (partially or wholly) to data. In some examples, and as discussed in further detail herein, the evaluation engine 122 can grant partial access to data by providing sanitized data. In some examples, if the evaluation engine 122 determines that the data does not include potentially sensitive data, the data is allowed to be transferred to the application 114 (i.e., the application 114 is granted full access to the data). In some examples, if the evaluation engine 122 determines that the data includes potentially sensitive data, a risk assessment can be performed to determine whether the application 114 is to be denied access or to be granted access (partial or full) to the data. In some examples, a risk assessment is performed regardless.

In some implementations, the evaluation engine 122 can receive information from each of the access control engine 124 and the risk evaluation engine 126. In some examples, the access control engine 124 retrieves one or more access and/or usage control policies from the policy store 128. For example, it can be determined that the data originated from the application 110 and that the application 110 is associated with a particular enterprise. The access control engine 124 can retrieve an access and/or usage control policy associated with the particular enterprise and/or data and can provide policy information to the evaluation engine 122. In some implementations, the access control engine 124 processes the data in view of the access and/or usage policy to determine which parts of the data the receiving application (e.g., the application 112) should be granted or denied access to. For example, a policy can provide that user data, or particular types or user data, is to never be provided from a first application (e.g., the application 110) to a second application (e.g., the application 114).

In some implementations, the evaluation engine 122 can evaluate the data in view of the access and/or usage control policy information provided from the access control engine 124. In some examples, for data and/or particular data types that access is to be denied to, the evaluation engine 122 can request a risk assessment before denying access to the data. In some examples, the evaluation engine can provide the data to the risk evaluation engine 126, which performs the risk assessment. In some implementations, and based on the risk assessment provided from the risk evaluation engine 126, the evaluation engine 122 can determine whether partial access to the data can be granted. In some examples, if partial access to the data is to be granted, the evaluation engine can sanitize the data (e.g., remove particular portions of the data) to provide sanitized data. The sanitized data can be provided to the IFL 120, which can provide the sanitized data to the application 112 instead of the (original) data. In some implementations, risk assessment is performed regardless of whether the access control policy indicates that access to the data should be granted or denied.

Implementations of risk evaluation (e.g., as conducted by the risk evaluation engine 126) will now be discussed. In some examples, risk can be defined as the likelihood of occurrence of an unwanted event. In some examples, unwanted events can include events that result from granting access to particular data. In implementations of the present disclosure, the risk of data flowing in an uncontrolled manner between two services (e.g., applications) is assessed.

In some examples, the invocation of a method m of a service s₂ (e.g., the application 112) by a service s₁ (e.g., the application 110) can cause a data object obj (or multiple data objects) to flow between s₁ and s₂. In the example context, the promotional offer management service can invoke a method of the recommendation engine and can provide one or more data objects to the recommendation engine. For example, the data flow df can be represented as a tuple:

df= [symbol] s1,s2,f,obj

[symbol]

In some examples, risk evaluation can associate the data flow df with a risk function rf( ). In some examples, the risk function rf( ) can use df as an input value and provide the risk if such a data flow is performed as output. In some examples, the risk function rf( ) can also the result rac from the access control engine as input. For example, the risk function rf( ) can be represented as:

$$rf ( df , rac ) = {\sum }_{{nu}_{obj} ∈ nu ( rac )} pr [ {nu}_{obj} \vert m ] * C ( {nu}_{obj} )$$

In some implementations, risk evaluation includes use of the function rf( ) to enumerate over all non-intended usages nu_{obj} (i.e., potential uses of the data object that are not intended by the data flow). For example, the function nu_{obj} and a set of non-intended usages can be defined by the operator of the providing application (e.g., the application 110). In the example context, the retail enterprise can provide the function nu_{obj} and a set of non-intended usages for the promotional offer management service. The probability of unintended use of a data object can be provided as:

pr[nu_{obj}|m]

Accordingly, the probability of unintended use of the data object can be defined in the context of invoking method m and an associated cost C(nu_{obj}). In some examples, the associated cost is provided in terms of financial cost (i.e., monetary units). For example, if data is disclosed when invoking a method, then this disclosure is assumed to be ultimately represented by a certain monetary amount. Within the example context of a retail enterprise, an unintended usage could be the release of the shopping history (e.g., alcohol purchase history) of a customer to a service (e.g., the application 112).

In some implementations, risk evaluation includes comparing the result of the function rf( ) (e.g., a risk factor) to an acceptable risk value (e.g., a risk threshold). In some examples, the acceptable risk value can be specific to the domain of the application and configuration application as selected by the operator (e.g., the retail enterprise). In some examples, if the result of the risk function exceeds the acceptable risk value, the data object is not to be provided to the receiving application (e.g., the application 112). If the result of the risk function does not exceed the acceptable risk value, the data object can be provided to the receiving application.

In some implementations, and as introduced above, risk assessment is performed regardless of whether the access control policy indicates that access to the data should be granted or denied. In some examples, if access to the data is to be granted, the risk assessment is anyway performed and the risk factor is compared to a first risk threshold. In some examples, if access to the data is to be denied, the risk assessment is performed and the risk factor is compared to a second risk threshold. In some examples, the first risk threshold is greater than the second risk threshold.

In some implementations, the data flow (the data) can include a plurality of data objects. In some examples, a first sub-set of data objects can include data objects that can be provided to the receiving application (e.g., data objects for which the respect risk function results do not exceed the acceptable risk value) and a second sub-set of data objects can include data objects that are not to be provided to the receiving application (e.g., data objects for which the respect risk function results are exceed the acceptable risk value). Consequently, the data can be sanitized to remove the second sub-set of data objects and the first sub-set of data objects can be provided to the receiving application as sanitized data.

Implementations of the present disclosure will be discussed in further detail below with reference to respective perspectives. The perspectives include the perspective of an application developer (e.g., a developer of services that can be hosted on the cloud platform and that can access functions provided by other services). In the example context, the application developer can include the developer of the promotional offer management service (e.g., the application 110). The perspectives also include the perspective of an operator or owner of a service that is hosted on the cloud platform and that accesses other services on the cloud platform. In the example context, the operator can include the retail enterprise that had the promotional offer management service (e.g., the application 110) developed. The perspectives further include the perspective of an end user. In the example context, the end user can include a customer of the retail enterprise that accesses the promotional offer management service.

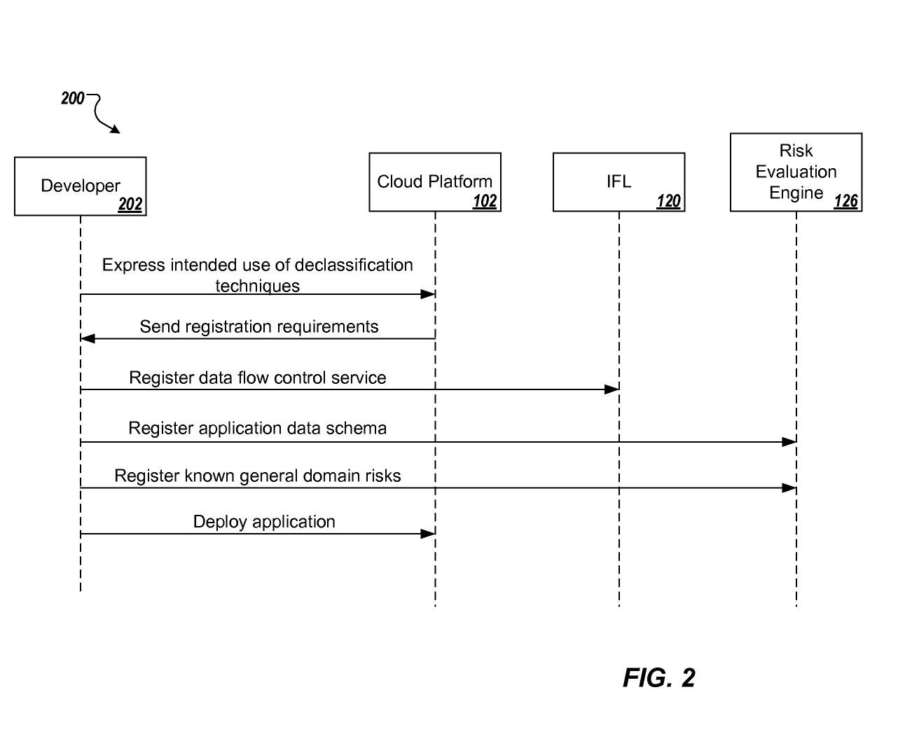

FIG. 2 depicts an example information flow 200 from the perspective of an application developer 202. In some implementations, the example information flow 200 can represent the interaction between an application developer 202 and components of the cloud platform 102 and the data flow control system 108. In general, the information flow 200 describes example steps to enable an application developer to have their application hosted on the cloud platform and to enable the data flow control system 108 to monitor and sanitize data flow from the application, if required. In the example of FIG. 2, the components include the cloud platform 108, the IFL 120 and the risk evaluation engine 126.

In some implementations, the application developer 202 can indicate to the cloud platform 102 that the application (e.g., the application 112) supports and adheres to the data flow control and declassification mechanisms offered by the cloud platform 102 (i.e., the functionality provided by the data flow control system 108). In some examples, and in response to the indication from the developer 202, the cloud platform 102 can provide registration requirements to the developer 202. In some implementations, the cloud platform 102 can point the developer 202 to packages that can be integrated in the application. That is, and from the technical perspective, the developer 202 defines the communication channels of the application (i.e., the service interfaces) and makes any data flow to and/or from the application observable by the IFL 120. Accordingly, the developer registers with the IFL 120. Further, the developer 202 can register the data schemas used by the application with the risk evaluation engine 126, and can also register a set of known domain-specific risks with the risk evaluation engine 126. In some implementations, the registration of application data schema and domain risks can enable the operator (e.g., the retail enterprise) to define and associate specific risks. In some implementations, the application developer 202 can deploy the application on the cloud platform 102. Deployment of the application enables the cloud platform 102 to implement the data flow control system 108 to monitor and sanitize data flow from the application.

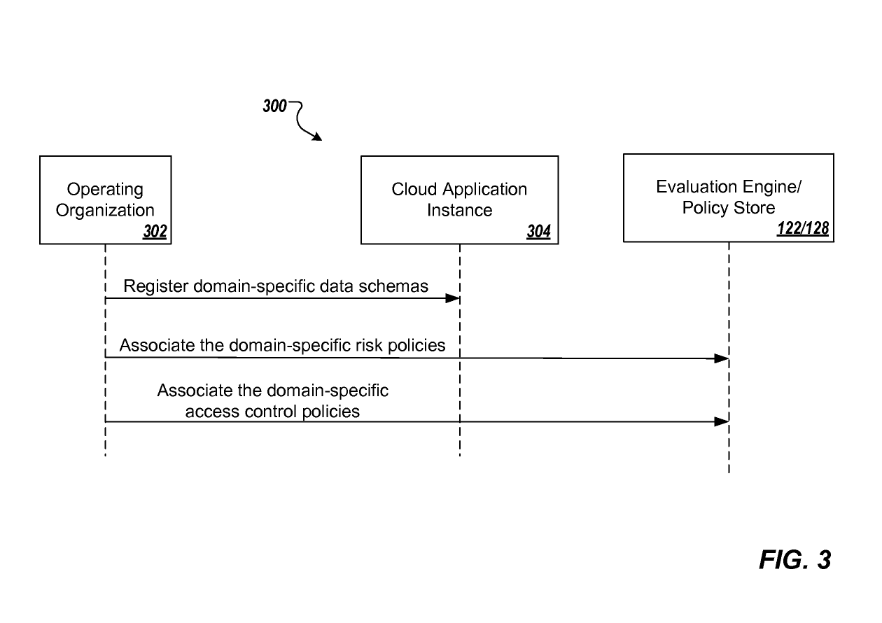

FIG. 3 depicts an example information flow 300 from the perspective of the owner of an application. In some implementations, the example information flow 300 can represent the interaction between an operating organization 302 (e.g., a retail enterprise) and multiple declassification components. In some implementations, the example information flow 300 can include information flow between the operating organization 302, a cloud application instance 304 and the evaluation engine/policy store 122, 128. In some examples, the cloud application instance 304 includes a service provided by the operating organization (e.g., the application 110 of FIG. 1).

In some implementations, the operating organization 302 can customize the application according to a particular set of requirements. In some examples, customization can enable the application to interact with a data flow control system to provide risk-based partial declassification. In some examples, customization can be achieved through interactions between the operating organization 302 and the cloud application instance 304 to register domain-specific data schemas (e.g., a customer profile for a retail chain), to associate a domain-specific risk profile (e.g., do not disclose consumer data to a specific service), and to associate domain-specific access control policies. In some examples, the domain-specific risk policies define which data can be shared and/or which data cannot be shared. In some implementations, if the domain-specific access control policies stored indicate that particular data cannot be shared, the evaluation engine 306 can analyze the risk policies to determine which part of the data flow could be shared. In some implementations, the access control policies may grant access if the risk is below a particular threshold, as discussed herein.

Within the example context, the operating organization 302 can include a retail enterprise (e.g., a supermarket chain). According to implementations of the present disclosure, the operating organization 302 can enable a service (e.g., the application 110) to interact with a data flow control system. For example, the operating organization 302 can register one or more domain-specific schemas with the cloud application instance 304. Within the example context, an example data schema can include a standard customer profile of the retail domain. In some implementations, the standard customer profile can be specific to a particular organization. For example, the standard customer profile can include information about a customer, such as name, address, average purchases per month, and purchase preferences.

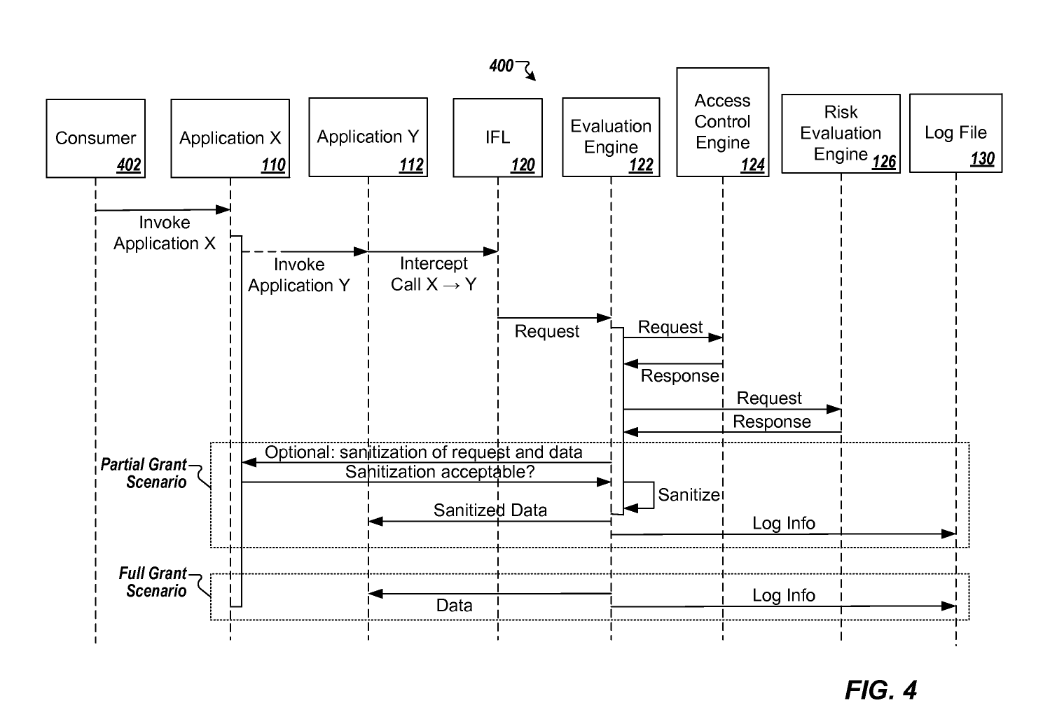

FIG. 4 depicts an example information flow 400 from the perspective of an end user. In some implementations, the example information flow 400 can represent the interactions that can result from a consumer 402 (e.g., the user 107 using the computing device 106) using the application 110. In some implementations, the example information flow 400 occurs between the consumer 402, the application 110, the application 112, an IFL 120, the evaluation engine 122, the access control engine 124, the risk evaluation engine 126 and the log file 130.

In the depicted example, the consumer 402 interacts with the application 110. In the example context, the application 110 can provide a promotion management system, from which the customer 402 can receive promotional offers. In some implementations, the application 110 interacts with another service provided by the application 112. In the example context, the application 112 can provide a recommendation engine to support services provided by the application 110. Consequently, the application 110 can generate a call including data to the application 112. That is, for example, consumer invocation of the application 110 can trigger a call to the application 112. In some implementations, the call is provided as a data flow that corresponds to a defined data schema and that is to be evaluated before being passed to the application 112.

In some implementations, the data flow is intercepted by the IFL 120. In some implementations, the IFL 120 can transmit a request to the evaluation engine 122 to conduct evaluation of the data that is to be provided to the application 112. In turn, the evaluation engine 122 can provide requests to the access control engine 124 and the risk evaluation engine 126. For example, the evaluation engine 122 can provide a request to the access control engine 124 to determine whether data provided in the data flow between the application 110 and the application 112 can be provided. In some implementations, the access control engine 124 references a pre-defined access control policy to determine whether the data transfer should be permitted or denied. In some implementations, the request to the risk evaluation engine 126 to access the overall risk if the data flow were allowed is transmitted in parallel.

In some implementations, the evaluation engine 122 receives responses from the access control engine 124 and the risk evaluation engine 126. In some examples, the response from the access control engine 124 can include a denial of access (i.e., blocking of the data flow) or a grant of access (i.e., allow the data flow). In some examples, the response from the risk evaluation engine 126 includes a risk assessment to determine the risk if the data flow were allowed. In some implementations, the evaluation engine 122 compares the risk assessment to a risk threshold. In some examples, the risk threshold is determined based on the response from the access control engine 124. For example, a denied request generated by the access control engine 124 can result in the risk threshold being provided at a first value, and a granted request generated by the access control engine 124 can result in the risk threshold being provided at a second value, where the second value is less than the first value. In this manner, if the data transfer is initially denied by the access control engine 124, the risk assessment can be compared to the risk threshold having the first value to determine whether the data transfer might nevertheless be allowed. Further, if the data transfer is initially granted by the access control engine 124, the risk assessment can be compared to the risk threshold having the second value to determine whether the data transfer might nevertheless be denied. In either case, if the risk assessment exceeds the risk threshold, the data flow is denied at least in part.

In some implementations, and in response to a denial, the evaluation engine 122 can sanitize the data to provide sanitized data. For example, if the data includes a plurality of data objects, the evaluation engine can remove one or more data objects and/or change values associated with data objects (e.g., to inert values). In some implementations, the evaluation engine 122 can provide the sanitized data to the risk evaluation engine 126 to update the risk assessment based on the sanitized data. In some implementations, the sanitization process can be performed one or more times, until it is determined that the risk assessment is below the risk threshold.

In some implementations, after it is determined that the sanitized data results in an acceptable risk level, the evaluation engine 122 can send a request to the application 110 to verify that the sanitized data is acceptable for use with the application 112. For example, the evaluation engine 122 can provide the sanitized data to the application 110, which can determine whether the sanitized data is sufficient for use by the application 112. For example, the application 110 can determine that a data object that is necessary for the application 112 to perform its service is absent from the sanitized data. In some examples, and in response, the application 110 can instead send another request (call) to the application 112 including less data than originally provided. Consequently, the sanitized data can be determined to be insufficient. In some implementations, the evaluation engine 122 can write information about the access and risk evaluation to the log file 130. In either case, whether the data is not sanitized (full grant scenario) or the data is sanitized (partial grant scenario), the evaluation engine 122 provides the data/sanitized data to the application 112 (e.g., via the IFL 120).

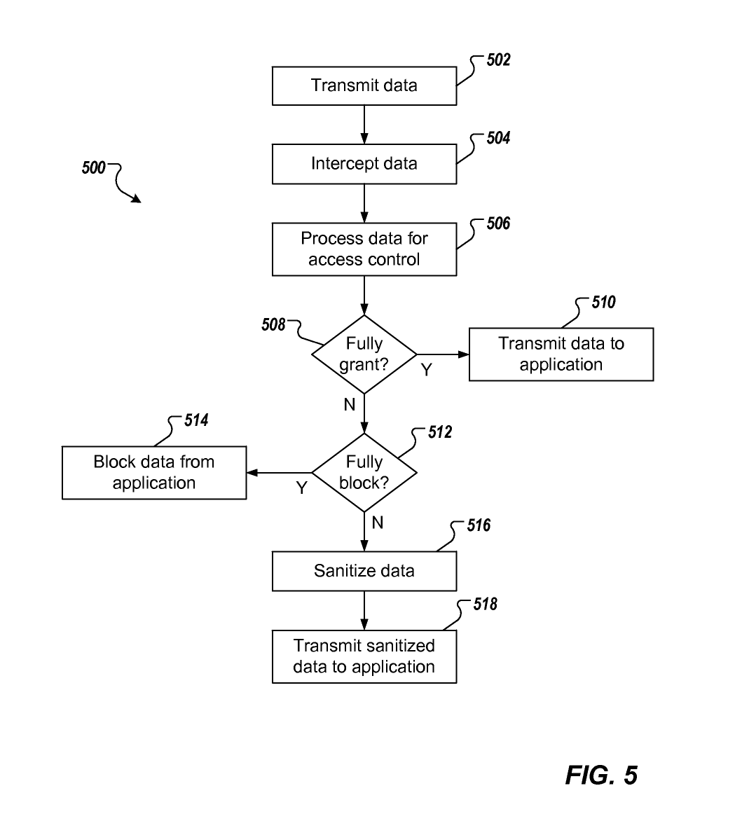

FIG. 5 is a flowchart depicting an example process 500 that can be executed in accordance with implementations of the present disclosure. In some implementations, the example process 500 can be implemented using one or more computer-executable programs that can be executed using one or more processors. For example, the example process 500 can be executed within the cloud platform 102 of FIG. 1.

Data is transmitted (502). For example, the application 110 transmits data intended for the application 112. The data is intercepted (504). For example, the IFL 120 of the data flow control system 108 intercepts the data and provides the data to the evaluation engine 122. The data is processed for an access control determination (506). For example, the evaluation engine 122 receives access control information from the access control engine 124 and a risk assessment from the risk evaluation engine 126. The evaluation engine 122 processes the access control information and the risk assessment, as discussed herein, to provide an access control determination. It is determined whether access to the data is fully granted (508). If access to the data is fully granted, the data is transmitted to a receiving application (510). For example, the evaluation engine 122 can transmit the data to the application 112 (e.g., via the IFL 120).

If access to the data is not fully granted, it is determined whether access to the data is fully blocked (512). For example, if the risk assessment exceeds the risk threshold, access to the data can be fully blocked. If access to the data is fully blocked, the data is blocked from being provided to the receiving application (514). For example, the evaluation engine 122 does not transmit the data to the application 112. If access to the data is not fully blocked, the data is sanitized to provide sanitized data (516). For example, the evaluation engine 122 removes one or more data objects and/or changes values of one or more data objects to provide the sanitized data. The sanitized data is transmitted to the receiving application (518). For example, the evaluation engine 122 transmits the sanitized data to the application 112 (e.g., via the IFL 120).

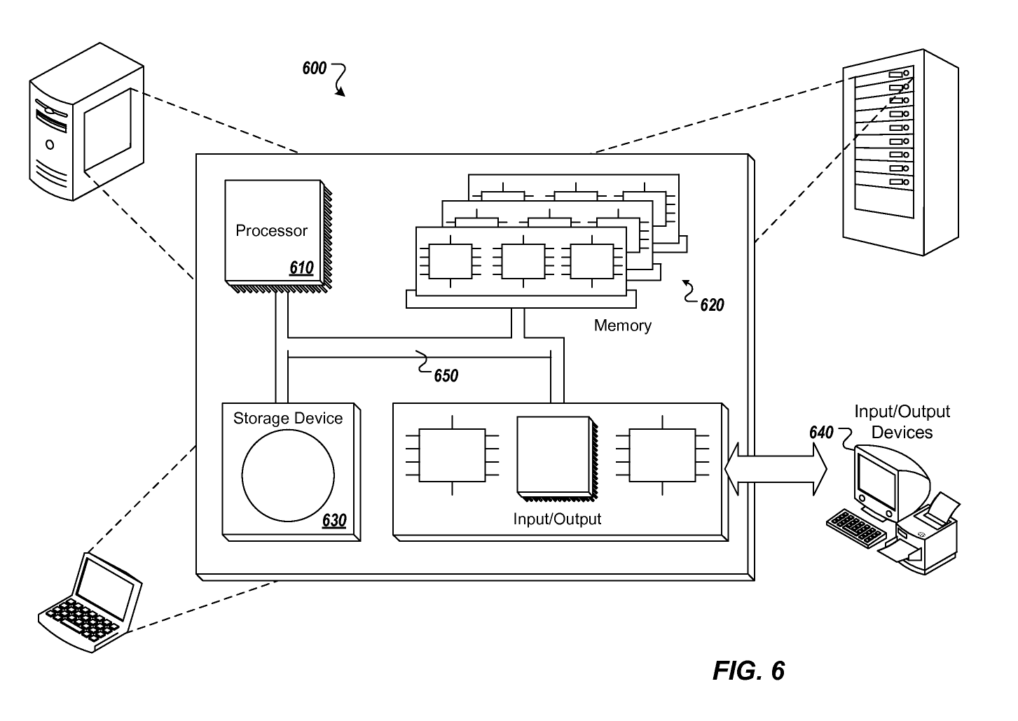

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit. The storage device 630 is capable of providing mass storage for the system 600. In one implementation, the storage device 630 is a computer-readable medium. In various different implementations, the storage device 630 may be a floppy disk device, a hard disk device, an optical disk device, or a tape device. The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for risk-based data flow control in a cloud environment, the method being executed using one or more processors and comprising:
intercepting first data transmitted from a first application to a second application before receipt of the first data at the second application, the first application and the second application being hosted within the cloud environment;
processing the first data to provide a first risk factor, the first risk factor reflecting a degree of risk if the first data is received by the second application;
generating first sanitized data based on the first data, the first risk factor and a first access control policy associated with the first data; and
transmitting the first sanitized data to the second application.

2. The method of claim 1, wherein the first sanitized data comprises less data than the first data.

3. The method of claim 1, wherein the first sanitized data comprises different data values than the first data.

4. The method of claim 1, wherein the first access control policy provides that access to the first data is to be denied.

5. The method of claim 4, wherein generating first sanitized data based on the first data, the first risk factor and a first access control policy associated with the first data comprises:
determining that access of the second application to the first data is denied based on the first access control policy;
selecting a risk threshold based on determining that access of the second application to the first data is denied; and
determining that the first risk factor exceeds the risk threshold and, in response, generating the first sanitized data.

6. The method of claim 1, wherein the first risk factor is determined based on one or more non-intended usages of at least a portion of the first data and one or more probabilities, each probability being associated with a respective non-intended usage.

7. The method of claim 1, further comprising deploying the first application to the cloud environment by:
expressing intended use of one or more declassification techniques,
providing registration requirements for the cloud environment,
registering a data flow control service at the cloud environment,
registering an application data schema of the first application and one or more general domain risks at the cloud environment, and
deploying the first application.

8. The method of claim 1, further comprising:
intercepting second data transmitted from the first application to the second application before receipt of the second data at the second application;
processing the second data to provide a second risk factor, the second risk factor reflecting a degree of risk if the second data is received by the second application; and
blocking transmission of the second data to the second application.

9. The method of claim 8, wherein blocking transmission of the second data to the second application occurs in response to determining that the second risk factor exceeds a risk threshold.

10. The method of claim 9, further comprising determining that a second access control policy associated with the second data provides that access to the second data is to be granted and, in response, providing a value of the risk threshold.

11. The method of claim 1, further comprising:
intercepting second data transmitted from the first application to the second application before receipt of the second data at the second application;
processing the second data to provide a second risk factor, the second risk factor reflecting a degree of risk if the second data is received by the second application; and
transmitting the second data to the second application.

12. The method of claim 11, wherein transmitting the second data to the second application occurs in response to determining that the second risk factor is less than a risk threshold.

13. The method of claim 12, further comprising determining that a second access control policy associated with the second data provides that access to the second data is to be granted and, in response, providing a value of the risk threshold.

14. The method of claim 1, wherein the risk comprises a risk of an unwanted event occurring as a consequence of providing the first data to the second application.

15. A non-transitory computer-readable storage medium coupled to one or more processors and having instructions stored thereon which, when executed by the one or more processors, cause the one or more processors to perform operations for risk-based data flow control in a cloud environment, the operations comprising:
intercepting first data transmitted from a first application to a second application before receipt of the first data at the second application, the first application and the second application being hosted within the cloud environment;
processing the first data to provide a first risk factor, the first risk factor reflecting a degree of risk if the first data is received by the second application;
generating first sanitized data based on the first data, the first risk factor and a first access control policy associated with the first data; and
transmitting the first sanitized data to the second application.

16. A system, comprising:
a computing device; and
a computer-readable storage device coupled to the computing device and having instructions stored thereon which, when executed by the computing device, cause the computing device to perform operations for risk-based data flow control in a cloud environment, the operations comprising:
intercepting first data transmitted from a first application to a second application before receipt of the first data at the second application, the first application and the second application being hosted within the cloud environment;
processing the first data to provide a first risk factor, the first risk factor reflecting a degree of risk if the first data is received by the second application;
generating first sanitized data based on the first data, the first risk factor and a first access control policy associated with the first data; and
transmitting the first sanitized data to the second application.
